(19) United States
(12) Patent Application Publication
(10) Pub. No.: US 2015/0120419 A1
(43) Pub. Date: Apr. 30, 2015

(54) SYSTEM AND METHOD FOR PROVIDING SALE ITEMS

(71) Applicant: WAL-MART STORES, INC., Bentonville, AR (US)

(72) Inventors: Melissa A. Byland, Bentonville, AR (US); Christine L. Andrews, Dr. Rogers, AR (US); Alan Gordon, San Francisco, CA (US); Christine Yick, San Bruno, CA (US); Shannon Gordon, San Francisco, CA (US)

(21) Appl. No.: 14/063,563

(22) Filed: Oct. 25, 2013

(51) Int. Cl. G06Q 30/02; G06Q 20/34

(52) U.S. Cl. CPC G06Q 30/0223; G06Q 20/342
USPC 705/14.24

(57) ABSTRACT

A system is provided that allows a customer to receive a guaranteed sales item when a sales item is not available on-hand at a retail store location. In one implementation, a limited in-store sale of an item may be provided such that if the customer meets certain criteria associated with the sale, that the customer is guaranteed the item, even if the item is not located at the retail location. In another implementation, each customer that is located at the retail store within a certain prescribed time of the sale may be guaranteed that the item is received by certain time.

### BACKGROUND

There are many different methods for providing an increased level of customer experience. For instance, programs and systems for conducting online purchases, layaway programs, offers and incentives, among others to increase sales and provide varied purchasing options for a customer, particularly in a retail setting.

### SUMMARY

It is appreciated that there are problems with certain forms of retail sales, such as “doorbuster” sales where a limited number of items are available and a high demand for the items usually occur. Such sales usually occur for a limited time or until certain on-hand quantities are exhausted. For instance, many holiday-related sales (e.g., Black Friday) have such types of items available. However, it is appreciated that many customers miss out on such sales because the quantities are exhausted or they miss the predetermined sales time, and therefore such customers become frustrated as a result.

According to one aspect, it is appreciated that it may be useful and particularly advantageous to allow for items to be guaranteed as available, even if in-store quantities are exhausted. For instance, according to one implementation, certain sale items are guaranteed of being available to a customer within a predetermined time limit from the start of the sale.

Also, it is appreciated that “rain checks” and other forms of reserve methods for reserving items for a customer are not sufficient, as many do not guarantee an item for a customer, especially within a certain amount of time. According to one embodiment, a customer is permitted to guarantee an item if they are located within a store within a certain period (e.g., a sales period) and the customer pays for that item during that visit.

Further, in one embodiment, a system and method is provided that allows a retailer to track such types of sales, such as by issuing a gift card for a desired item that is not available on-hand in the store. In one implementation, the customer purchases the gift card at the store location for the amount of the item plus any other amounts (e.g., sales tax). The customer registers the card on the website and the item may be shipped to the store (e.g., at no cost) within a predefined period of time (e.g., before Christmas). Alternatively, the item may be shipped to the customer directly to the customer. For instance, the customer may elect to pay additional shipping charges for the convenience of receiving the item directly.

In one embodiment, a customer may use a mobile device, when located at the store, to purchase the gift card. For instance, a specialized application program (e.g., an “app”) may be provided to the customer that allows the customer to purchase the gift card at the store location. In one embodiment, the gift card is a virtual gift card. In any case, the gift card may be redeemed for the item upon availability. Funds allocated to the gift card could be “swept off” at a time at which the item is available at the store, at a redemption time (e.g., pickup at the store, shipment directly to the customer, etc.), or other designated time.

In another embodiment, it is appreciated that a certain type of gift card may be allocated to such a sale. For instance, special gift cards within a certain card identifier range may be used. For instance, according to one embodiment, a certain Bank Identification Number (BIN) or other type of identifier may be used to indicate which gift cards are associated with the sales transaction. Further, a validation number or other identifier may be provided that allows the customer to complete a transaction. For instance, when redeeming the card on a website, the customer may provide an identifier associated with the gift card along with the validation number or other identifier. According to one embodiment, such information may be used to authenticate the gift card and permit the user to complete the transaction.

In yet another embodiment of the present invention, the system that allows a customer to redeem the gift card for the specified item may also permit the customer to purchase any of the other items associated with the sale for which the customer appeared. Such information may be stored on a website, for example, and the item chosen may be communicated to an order management system to fulfill the transaction.

According to one aspect of the present invention, a distributed computer system is provided for processing an item for sale. The distributed system comprises a system configured to issue a payment instrument to a customer in exchange for a guaranteed sales item associated with a limited sale at a retail location of a retailer, the guaranteed sales item not being available from on-hand stock at the retail location, and a system configured to redeem the payment instrument for the guaranteed sales item. According to one embodiment, the system includes an interface that permits the customer to redeem the payment instrument.

According to another embodiment of the present invention, the guaranteed sales item associated with a limited sale at a retail location is allocated within a stream of commerce of the retailer responsive to the purchase of the payment instrument by the customer. According to another embodiment, the interface is configured to accept an access code provided by the customer to redeem the payment instrument.

According to another embodiment, the payment instrument is at least one of a group comprising an actual gift card, a virtual gift card, a prepaid card, and a debit card. According to another embodiment, the system is configured to generate an access code to the customer responsive to the issue of the payment instrument. According to another embodiment, the system stores the access code and stores an association of the code with an identification of the guaranteed sales item associated with the limited sale at the retail location of the retailer.

According to another embodiment, the system is further configured to restrict redemption of the payment instrument to the guaranteed sales item. According to yet another embodiment, the system is further configured to restrict redemption of the payment instrument to one or more sales items associated with the limited sale at the retail location. In another embodiment, the interface is configured to permit the user to select from a limited number of sales items for redemption.

According to one embodiment, the interface is configured to permit the user to select a shipping destination for the guaranteed sales item. In yet another embodiment, the shipping destination includes at least one of a group comprising a retail location, a location associated with a customer, and a location associated with a third party.

In one embodiment, the system permits the customer to redeem the payment instrument responsive to providing the access code. In another embodiment, the system permits the customer to provide an identifier of the payment instrument and the access code to redeem the guaranteed item. In yet another embodiment, the system is configured to provide a guaranteed delivery time limit of the guaranteed item to the customer.

According to another embodiment, the distributed system further comprises a system configured to fulfill an order for the guaranteed item. In another embodiment, the system that is configured to fulfill the order for the guaranteed item is configured to allocate the guaranteed item within a supply chain of the retailer. In yet another embodiment, the system that is configured to fulfill the order for the guaranteed item is configured to schedule delivery by a guaranteed time limit for the guaranteed item.

According to another aspect of the present invention, a computer-implemented method for processing an item for sale is provided. The method comprises acts of issuing, by a computer system, a payment instrument to a customer in exchange for a guaranteed sales item associated with a limited sale at a retail location of a retailer, the guaranteed sales item not being available from on-hand stock at the retail location, and redeeming the payment instrument for the guaranteed sales item.

In one embodiment, the method further comprises an act of permitting the customer to redeem the payment instrument using an interface of the computer system. In one embodiment, the guaranteed sales item associated with a limited sale at a retail location is to allocated within a stream of commerce of the retailer responsive to an act of purchasing the payment instrument by the customer. In one embodiment, the method further comprises an act of accepting, by the interface, an access code provided by the customer to redeem the payment instrument.

In one embodiment, the payment instrument is at least one of a group comprising an actual gift card, a virtual gift card, a prepaid card, and a debit card. In one embodiment, the method further comprises an act of generating, by the computer system, an access code to the customer responsive to the issue of the payment instrument. In one embodiment, the computer system is configured to store the access code and the method comprises an act of storing an association of the access code with an identification of the guaranteed sales item associated with the limited sale at the retail location of the retailer. In one embodiment, the method further comprises an act of restricting redemption of the payment instrument to the guaranteed sales item. In one embodiment, the method further comprises an act of restricting redemption of the payment instrument to one or more sales items associated with the limited sale at the retail location. In one embodiment, the method further comprises an act of permitting the user, within the interface, to select from a limited number of sales items for redemption. In one embodiment, the method further comprises an act of permitting the user, within the interface, to select a shipping destination for the guaranteed sales item.

In one embodiment, the shipping destination includes at least one of a group comprising a retail location, a location associated with a customer, and a location associated with a third party. In one embodiment, the method further comprises an act of permitting the customer, within the interface, to redeem the payment instrument responsive to providing the access code. In one embodiment, the method further comprises an act of permitting the customer, within the interface, to provide an identifier of the payment instrument and the access code to redeem the guaranteed item. In one embodiment, the method further comprises an act of providing, by the computer system, a guaranteed delivery time limit of the guaranteed item to the customer. In one embodiment, the method further comprises an act of fulfilling, by a fulfillment system, an order for the guaranteed item. In one embodiment, the method further comprises an act of allocating, by the fulfillment system, the guaranteed item within a supply chain of the retailer. In one embodiment, the method further comprises an act of scheduling, by the fulfillment system, delivery of the guaranteed item by a guaranteed time limit

Still other aspects, examples, and advantages of these exemplary aspects and examples, to are discussed in detail below. Moreover, it is to be understood that both the foregoing information and the following detailed description are merely illustrative examples of various aspects and examples, and are intended to provide an overview or framework for understanding the nature and character of the claimed aspects and examples. Any example disclosed herein may be combined with any other example in any manner consistent with at least one of the objects, aims, and needs disclosed herein, and references to “an example,” “some examples,” “an alternate example,” “various examples,” “one example,” “at least one example,” “ this and other examples” or the like are not necessarily mutually exclusive and are intended to indicate that a particular feature, structure, or characteristic described in connection with the example may be included in at least one example. The appearances of such terms herein are not necessarily all referring to the same example.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and examples, and are incorporated in and constitute a part of this specification, but are not intended as a definition of the limits of a particular example. The drawings, together with the remainder of the specification, serve to explain principles and operations of the described and claimed aspects and examples. In the figures, each identical or nearly identical component that is illustrated in various figures is represented by a like numeral. For purposes of clarity, not every component may be labeled in every figure. In the figures:

FIG. 1 is a block diagram showing a distributed computer system suitable for implementing various aspects of the present;

FIG. 2 shows a process for providing one or more sales items to a customer according to various embodiments of the present invention;

FIG. 3 shows another process for providing one or more sales items to a customer according to various embodiments of the present invention;

FIG. 4 shows example information that may be used to access a sales redemption system according to one embodiment of the present invention;

FIG. 5 shows a process for restricting a redemption of a gift card for particular sales items according to one embodiment of the present invention;

FIG. 6 shows a process for redeeming a gift card for particular sales items according to one embodiment of the present invention;

FIG. 7 shows an example computer system upon which various aspects of the present invention may be practiced; and

FIG. 8 shows an example storage system capable of implementing various aspects of the present invention.

### DETAILED DESCRIPTION

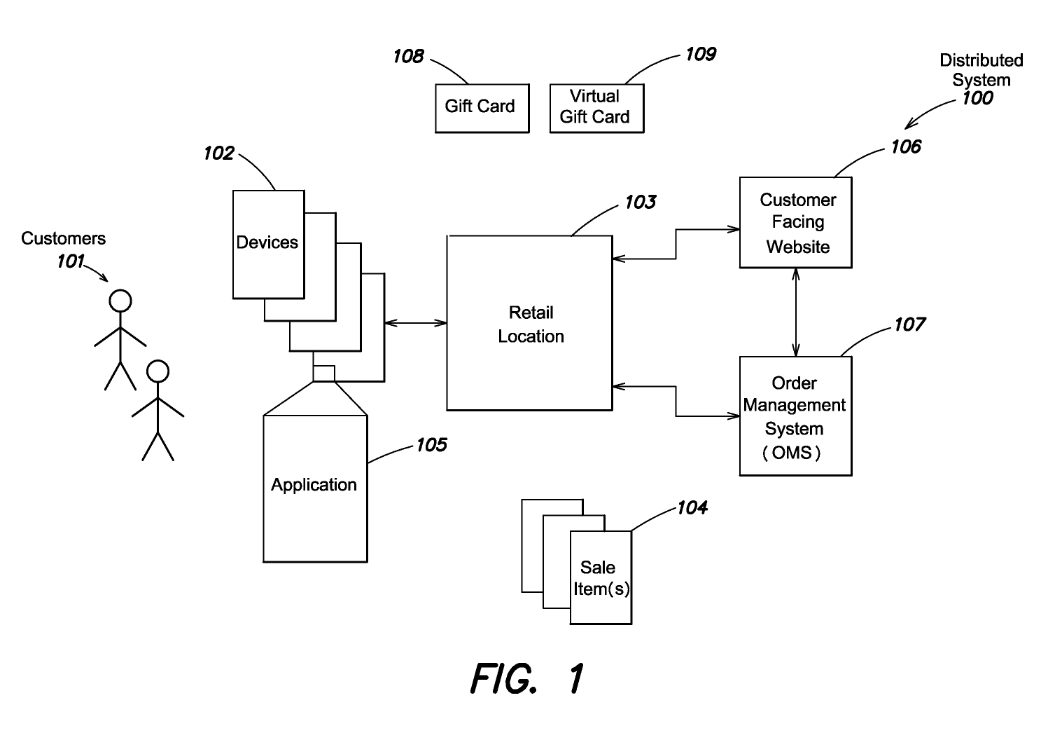

FIG. 1 shows a block diagram of a system 100 suitable for implementing various aspects of the present invention. In particular, according to one embodiment, FIG. 1 shows a distributed computer system 100 that includes one or more computer systems and/or devices that are capable of implementing various aspects of the present invention. In particular, one or more customers 101 may desire to purchase one or more sale items (e.g., items 104) associated with a retail location (e.g., retail location 103).

As discussed, a retail location may conduct a sale of some items that have limited on-hand quantities. Conventionally, such items are usually sold as first-come, first serve until the on-hand amounts of such items are exhausted. According to one aspect of the present invention, a limited in-store sale of such items may be provided that if a customer meets certain criteria associated with the sale, that the customer may be guaranteed the item, even if the item is not located at the retail location. For instance, each customer that is located at the retail store within a certain prescribed time for the sale may have a guarantee that the item will be available.

Also, according to another embodiment, the item may be guaranteed to the customer by a particular date. For instance, in the case of a Black Friday sale, it may be beneficial for the customer to be guaranteed delivery of the item in time for Christmas. In conventional sales formats, no such guarantees are made, and typically when on-hand items are exhausted, customers must search many other retail stores, locations, and sources to find the desired items, thus adding to their frustration. Also, it is appreciated that if a certain item is guaranteed, turnout for the sale may be increased, as customers are guaranteed to receive the item, and the item may be a popular item that is common to many customer's interest.

According to one embodiment of the present invention, a type of sale and supporting systems are provided that permit a customer to be guaranteed to receive a sales item if the customer is located at the retail location for a predetermined time of the sale. Such a format may also require that the customer prepay for the item in total to reserve the item for delivery by a prescribed date. In one example implementation, to ensure the customer receives a guaranteed item, it may be required that a gift card may be purchased by the customer at the retail location for the amount of the sales item (plus any additional expense such as sales tax). Custom gift cards may be provided for purchasing such sales items, and redemption of such gift cards may be restricted by a redemption system to only such items that were available at the time of the sale. In one example, the redemption may be limited to the item that was guaranteed to the customer to ensure that the retailer does not order excess on-hand amounts of the item.

Customers may receive such gift cards either as physical gift cards, virtual gift cards, or as some other form or token of payment. According to one implementation, customers 101 may receive information about such sales via one or more respective personal devices (e.g., devices 102), and may use such devices for purchasing gift cards associated with sales items. Gift cards may be provided at the point of sale (e.g., at the retail location conducting the sale) and may be activated in a similar manner as conventional gift cards using in-store computer systems that receive payment from a customer and activate the gift cards through a communication network using identifiers of the gift cards to be activated. However, according to one embodiment, the gift card(s), when issued have a restriction placed on their use to redeem the amounts associated with the designated sales item(s) purchased associated with the sale.

Customers may be provided one or more methods for redeeming such gift cards, such as through a customer facing website (e.g., website 106), through an application (e.g., application 105 that executes on one or more mobile devices (e.g., devices 102). For instance, the application may be configured to use location services of the mobile device to determine that the customer user is located at or near the retail location during a prescribed time of the sale, and thus the customer is permitted to purchase the sale item. The customer may be permitted to purchase the gift card (e.g., a “real” gift card 108 or a virtual gift card 109) to purchase the sale item that is not on-hand at the retail location.

The gift card may be redeemed online, and the item(s) associated with the gift card may be shipped to the retail location, customer, or other location (e.g., to a gift recipient address). According to one aspect of the present invention, the system may be integrated with an order management system (OMS) (e.g., OMS 107) for the purpose of executing an order including a sales item, processing the transfer of funds from the gift card or other payment instrument, and arranging a fulfillment of the order of the sales item. According to one embodiment, the OMS may be integrated with a fulfillment system that is capable of fulfilling a particular customer order.

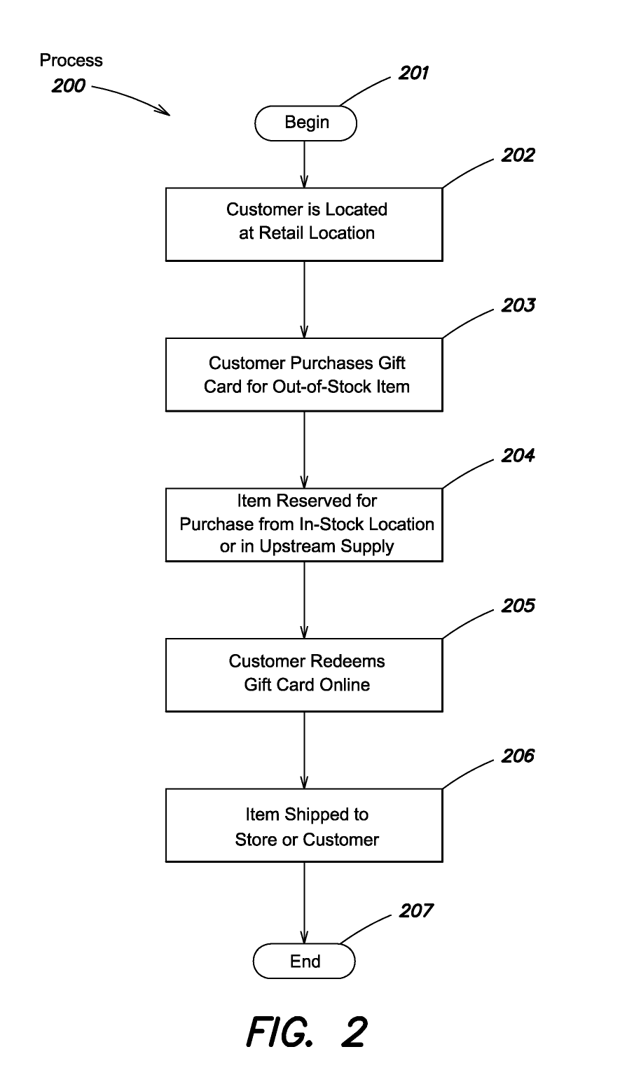

FIG. 2 shows an example process 204 providing one or more sales items to a customer according to various embodiments of the present invention. At block 201, process 200 begins. At block 202, is determined that a customer is located at a particular retail location. For instance, a sale may be conducted at a particular retail location, and the customer proceeds to that location during the time of the sale. According to one embodiment, the customer may need to meet certain criteria in order to participate in the sale and be guaranteed a sales item, such as, for example, being located at the store during a certain time period (e.g., within one hour of the beginning of the sale). To this end, there may be one or more systems that restrict the purchase of a gift card by the customer that does not fulfill particular criteria, such as for example, a location-based application that does not permit the purchase of the gift card if the customer is not located at the store at the prescribed time.

At block 203, the customer (if permitted by a POS system, application or other system) purchases the gift card for the out-of-stock item. As discussed above, the gift card may be a special gift card that is issued in an amount of the purchase price for the particular sales item, plus any necessary fees (e.g., taxes, shipping or other fees). At block 204, the sales item is reserved for the customer from another in-stock location (e.g., a sales item located at another store) or at some point within the upstream supply (e.g., an unreceived order of the sales item).

At block 205, the customer redeems the gift card online. For instance, the customer may access a website associated with the gift card, they provide some information, and the website may allow the customer to provide their information, shipping information, or other information relevant to the receipt of the sales item. Once processed, the item may be shipped to the store, directly to the customer, or to some other party at block 206. At block 207, process 200 ends.

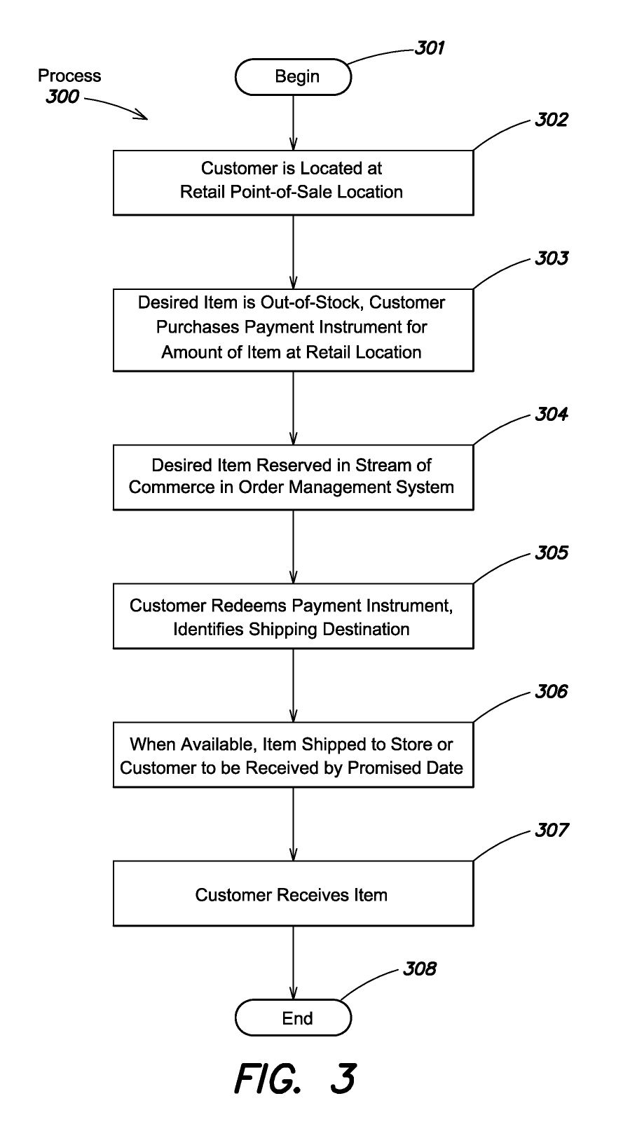

FIG. 3 shows another process for providing one or more sales items to a customer according to various embodiments of the present invention. At block 301, process 300 begins. At block 302, the customer locates to a retail point-of-sale location. For example, the customer goes to a physical retail store location that is conducting a sale including one or more sales items. At block 303, is determined that the desired item is out-of-stock at the retail location, and the customer purchases a payment instrument for the amount of the item at the retail location. For instance, the payment instrument may include a gift card, a virtual gift card, a prepaid debit card, or other instrument that has value.

At block 304, the desired sales item is reserved in the stream of commerce within an order management system (OMS). For instance, the sales item may be located in stock in other retail locations. However, in another implementation, the sales item may not be received yet by any retail locations and the customer may benefit by being able to receive the out-of-stock item without the item necessarily being within stock at another retail location.

At block 305, the customer redeems the payment instrument. For example, the customer may redeem the payment instrument online, in the store, at another retail location, among other methods and locations. Further, the customer may specify shipping destination which may include the store that the customer most frequents or any other location identified by the customer. At block 306, the item is shipped to the designated location (e.g., the store, the customer or third party location) when the item is available, and the item is shipped in the method such that the item will be received by the promised date. For example, the sale may be a Black Friday sale and the date by which the sales item is promised to be received is a set date prior to the Christmas holiday. At block 307, the customer receives the item. At block 308, process 300 ends.

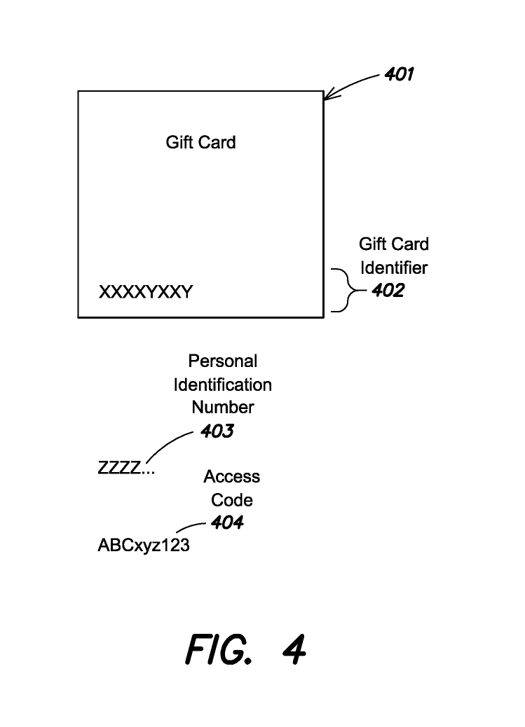

FIG. 4 shows example information that may be used to access a sales redemption system according to one embodiment of the present invention. As discussed above, a physical gift card (e.g., gift card 401) may be issued to a customer at the point-of-sale. Such a gift card may include a gift card identifier 402. Gift card identifier information may include for example, an issuer identification number (IIN), bank identification number (BIN), or other identifier of the gift card. Also, a specific number uniquely identifying the gift card may be included in the gift card identifier. According to one embodiment, certain identification numbers may be reserved for gift cards associated with sales items. Further, a personal identification number (PIN) 403 may be provided that is used to access the gift card funds, although it should be appreciated that some gift cards may not require a PIN. In one embodiment, the PIN may be a four digit number associated with the card.

Activation of a card may occur at the point-of-sale when funds are loaded on the card. For instance, the card may be swiped by the cashier using a keypad or other scanning device and activated through a communication network at the retail store. The gift card may be issued for a particular amount, and in one embodiment, the amount may not “reloadable” or may not have a line of credit such as a credit card.

Further, an access code (e.g., access code 404) may be provided that permits the customer to redeem the card (e.g., online). For instance, this access code may be provided at the point-of-sale to the customer to allow the customer to redeem the card. Such information may have any format and length, and may be provided by any method. In one implementation, the access code may be printed on a receipt associated with a purchase of the gift card for the sales item.

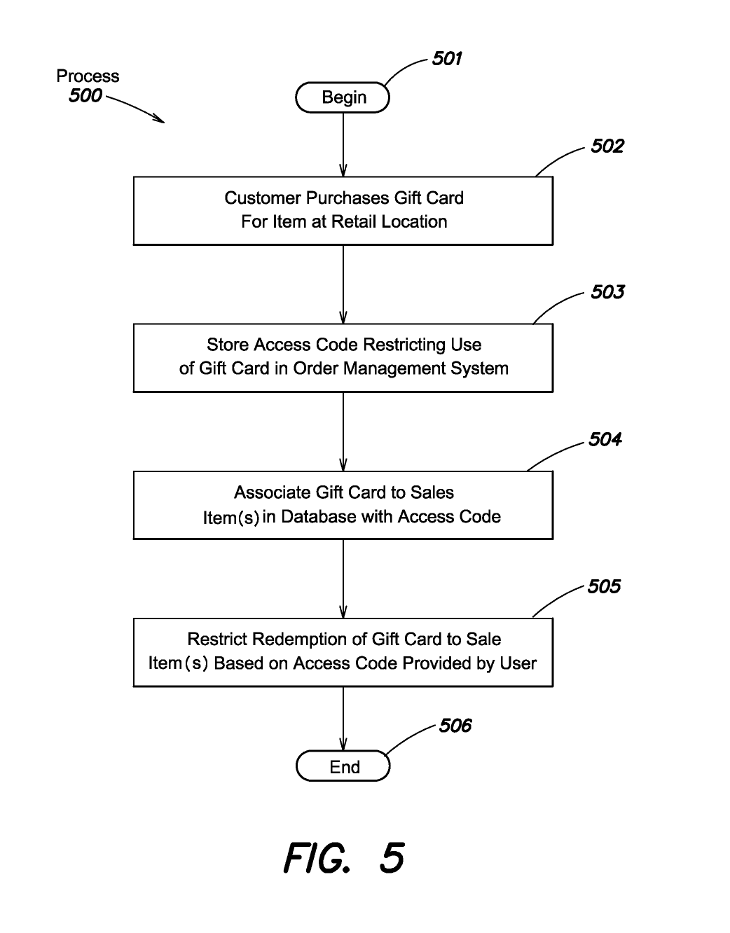

FIG. 5 shows a process 500 for restricting a redemption of a gift card for particular sales items according to one embodiment of the present invention. For instance according to one embodiment, the gift card may be restricted to use associated with particular sales item. For instance, in exchange for guaranteeing that the customer may receive a sales item that is allocated by the retailer within the stream of commerce, the gift card may be restricted to purchase of the particular sales item. In another embodiment, the customer may be restricted to any sales item that was available at the time that the customer met the criteria of the sale.

At block 501, process 500 begins. At block 502, the customer purchases the gift card for a particular item or items at the retail location. At block 503, an access code is generated and stored that restricts the use of the gift card within an order management system. That is, information identifying a particular restriction on a particular card is stored within the distributed computer system. This information may be used to restrict use of the gift card in various locations to the purchase of the particular item(s).

At block 504, the distributed computer system associates the gift card to sales items, and the association is stored along with the access code in a memory of a computer system. At block 505, the system restricts the redemption of the gift card sales item(s) based on the access code provided by the user (e.g., the customer). At block 505, process 500 ends.

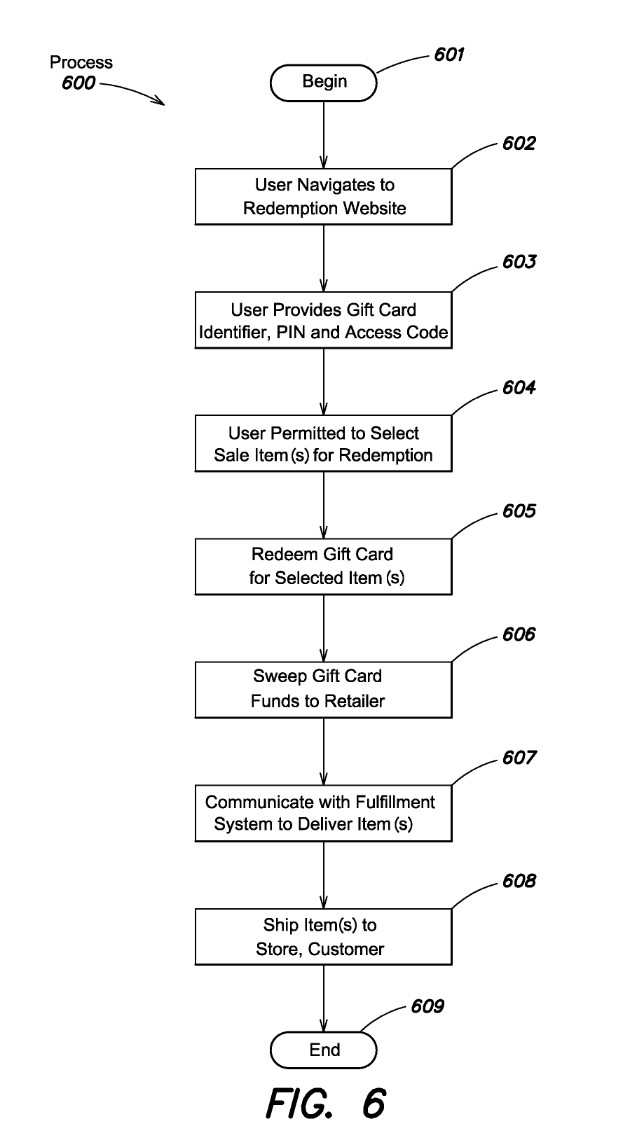

FIG. 6 shows a process 600 for redeeming the gift card by a customer for particular sales items according to one embodiment of the present invention. At block 601, process 600 begins. At block 602, a user (e.g., a customer) navigates within an interface of a computing device to a website for redeeming gift cards. Alternatively, the user may use an application program that provides similar redemption functions. At block 603, a user (e.g., a customer) provides a gift card identifier, any PIN (if necessary), and the provided access code. At block 604, the user is permitted to select one or more sales items for redemption. At this point, the user may provide additional information, such as personal information, shipping information for the sales items, among other information related to the transaction.

At block 605, the system redeems the gift card for the selected items. At block 606, the system sweeps any funds associated with the gift card to the retailer. That is, according to one embodiment, the funds are held by gift card provider or account of the retailer and the funds are transferred once allocated to the purchase of the sales item. At block 607, the system may communicate with a settlement system to arrange delivery of the sales item(s), and at block 608, the items are shipped to the designated location including but not limited to the store, the customer or any third party. At block 609, process 600 ends.

### EXAMPLE COMPUTER IMPLEMENTATIONS

Processes described above are merely illustrative embodiments of systems that may be used to facilitate sale of sales items. Such illustrative embodiments are not intended to limit the scope of the present invention, as any of numerous other implementations for performing the invention. None of the claims set forth below are intended to be limited to any particular implementation of an item processing system, unless such claim includes a limitation explicitly reciting a particular implementation.

Processes and methods associated with various embodiments, acts thereof and various embodiments and variations of these methods and acts, individually or in combination, may be defined by computer-readable signals tangibly embodied on a computer-readable medium, for example, a non-volatile recording medium, an integrated circuit memory element, or a combination thereof. According to one embodiment, the computer-readable medium may be non-transitory in that the computer-executable instructions may be stored permanently or semi-permanently on the medium. Such signals may define instructions, for example, as part of one or more programs, that, as a result of being executed by a computer, instruct the computer to perform one or more of the methods or acts described herein, and/or various embodiments, variations and combinations thereof. Such instructions may be written in any of a plurality of programming languages, for example, Java, Visual Basic, C, C#, or C++, Fortran, Pascal, Eiffel, Basic, COBOL, etc., or any of a variety of combinations thereof. The computer-readable medium on which such instructions are stored may reside on one or more of the components of a general-purpose computer described above, and may be distributed across one or more of such components.

The computer-readable medium may be transportable such that the instructions stored thereon can be loaded onto any computer system resource to implement the aspects of the present invention discussed herein. In addition, it should be appreciated that the instructions stored on the computer-readable medium, described above, are not limited to instructions embodied as part of an application program running on a host computer. Rather, the instructions may be embodied as any type of computer code (e.g., software or microcode) that can be employed to program a processor to implement the above-discussed aspects of the present invention.

Various embodiments according to the invention may be implemented on one or more computer systems. These computer systems may be, for example, general-purpose computers such as those based on Intel PENTIUM-type processor, Motorola PowerPC, Sun UltraSPARC, Hewlett-Packard PA-RISC processors, ARM Cortex processor, Qualcomm Scorpion processor, or any other type of processor. It should be appreciated that one or more of any type computer system may be used to partially or fully automate management of prepaid debit cards according to various embodiments of the invention. Further, the sales item ordering system may be located on a single computer or may be distributed among a plurality of computers attached by a communications network.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

A computer system may be a general-purpose computer system that is programmable using a high-level computer programming language. Computer system may be also implemented using specially programmed, special purpose hardware. In a computer system there may be a processor that is typically a commercially available processor such as the well-known Pentium class processor available from the Intel Corporation. Many other processors are available. Such a processor usually executes an operating system which may be, for example, the Windows NT, Windows 2000 (Windows ME), Windows XP, Windows Vista, Windows 7, or Windows 8 operating systems available from the Microsoft Corporation, MAC OS X Snow Leopard, MAC OS X Lion operating systems available from Apple Computer, the Solaris Operating System available from Sun Microsystems, iOS, Blackberry OS, Windows 7 Mobile or Android OS operating systems, or UNIX available from various sources. Many other operating systems may be used.

Some aspects of the invention may be implemented as distributed application components that may be executed on a number of different types of systems coupled over a computer network. Some components may be located and executed on mobile devices, servers, tablets, or other system types. Other components of a distributed system may also be used, such as databases (e.g., the mongoDB database), cloud services, or other component types.

The processor and operating system together define a computer platform for which application programs in high-level programming languages are written. It should be understood that the invention is not limited to a particular computer system platform, processor, operating system, or network. Further, it should be appreciated that multiple computer platform types may be used in a distributed computer system that implements various aspects of the present invention. Also, it should be apparent to those skilled in the art that the present invention is not limited to a specific programming language or computer system. Further, it should be appreciated that other appropriate programming languages and other appropriate computer systems could also be used.

One or more portions of the computer system may be distributed across one or more computer systems coupled to a communications network. These computer systems also may be general-purpose computer systems. For example, various aspects of the invention may be distributed among one or more computer systems configured to provide a service (e.g., servers) to one or more client computers, or to perform an overall task as part of a distributed system. For example, various aspects of the invention may be performed on a client-server system that includes components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP). Certain aspects of the present invention may also be implemented on a cloud-based computer system (e.g., the EC2 cloud-based computing platform provided by Amazon.com), a distributed computer network including clients and servers, or any combination of systems.

It should be appreciated that the invention is not limited to executing on any particular system or group of systems. Also, it should be appreciated that the invention is not limited to any particular distributed architecture, network, or communication protocol.

Various embodiments of the present invention may be programmed using an object-oriented programming language, such as SmallTalk, Java, C++, Ada, or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented as programmed or non-programmed elements, or any combination thereof.

Further, on each of the one or more computer systems that include one or more components of distributed system 100, each of the components may reside in one or more locations on the system. For example, different portions of the components of system 100 may reside in different areas of memory (e.g., RAM, ROM, disk, etc.) on one or more computer systems. Each of such one or more computer systems may include, among other components, a plurality of known components such as one or more processors, a memory system, a disk storage system, one or more network interfaces, and one or more busses or other internal communication links interconnecting the various components.

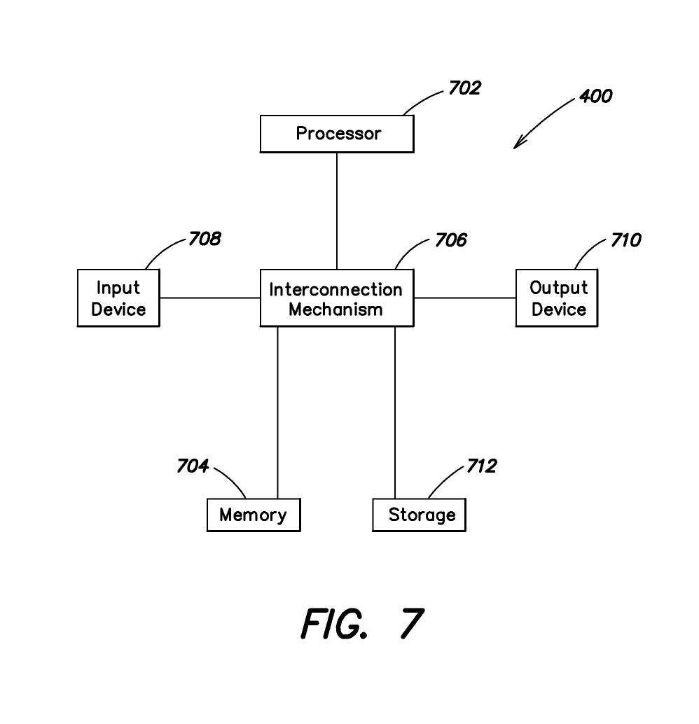

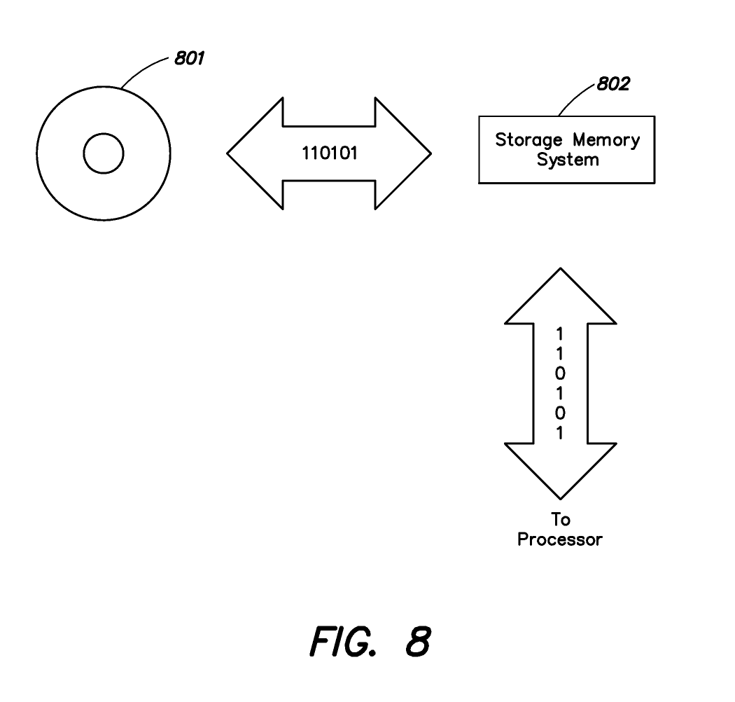

Any number of systems of system 100 may be implemented on a computer system described below in relation to FIGS. 7 and 8. In particular, FIG. 7 shows an example computer system 700 used to implement various aspects. FIG. 8 shows an example storage system that may be used.

System 700 is merely an illustrative embodiment of a computer system suitable for implementing various aspects of the invention. Such an illustrative embodiment is not intended to limit the scope of the invention, as any of numerous other implementations of the system, for example, are possible and are intended to fall within the scope of the invention. For example, a virtual computing platform may be used. None of the claims set forth below are intended to be limited to any particular implementation of the system unless such claim includes a limitation explicitly reciting a particular implementation.

For example, various aspects of the invention may be implemented as specialized software executing in a general-purpose computer system 700 such as that shown in FIG. 4. The computer system 700 may include a processor 703 connected to one or more memory devices 704, such as a disk drive, memory, or other device for storing data. Memory 704 is typically used for storing programs and data during operation of the computer system 700. Components of computer system 700 may be coupled by an interconnection mechanism 705, which may include one or more busses (e.g., between components that are integrated within a same machine) and/or a network (e.g., between components that reside on separate discrete machines). The interconnection mechanism 705 enables communications (e.g., data, instructions) to be exchanged between system components of system 700. Computer system 700 also includes one or more input devices 702, for example, a keyboard, mouse, scanner, trackball, microphone, touch screen, and one or more output devices 701, for example, a printing device, display screen, and/or speaker. The system may also include any specialized components depending on the application, including any barcode reader, magnetic stripe reader, receipt printer, hand-held or fixed scanners, pin entry devices (PED), or other device types. In addition, computer system 700 may contain one or more interfaces (not shown) that connect computer system 700 to a communication network (in addition or as an alternative to the interconnection mechanism 705).

The storage system 706, shown in greater detail in FIG. 8, typically includes a computer readable and writeable nonvolatile recording medium 801 in which signals are stored that define a program to be executed by the processor or information stored on or in the medium 801 to be processed by the program. The medium may, for example, be a disk or flash memory. Typically, in operation, the processor causes data to be read from the nonvolatile recording medium 801 into another memory 802 that allows for faster access to the information by the processor than does the medium 801. This memory 802 is typically a volatile, random access memory such as a dynamic random access memory (DRAM) or static memory (SRAM). It may be located in storage system 706, as shown, or in memory system 704, not shown. The processor 703 generally manipulates the data within the integrated circuit memory 704, 802 and then copies the data to the medium 801 after processing is completed. A variety of mechanisms are known for managing data movement between the medium 801 and the integrated circuit memory element 704, 802, and the invention is not limited thereto. The invention is not limited to a particular memory system 704 or storage system 706.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

Although computer system 700 is shown by way of example as one type of computer system upon which various aspects of the invention may be practiced, it should be appreciated that aspects of the invention are not limited to being implemented on the computer system as shown in FIG. 7. Various aspects of the invention may be practiced on one or more computers having a different architecture or components that that shown in FIG. 7.

Computer system 700 may be a general-purpose computer system that is programmable using a high-level computer programming language. Computer system 700 may be also implemented using specially programmed, special purpose hardware. In computer system 700, processor 703 is typically a commercially available processor such as the well-known Pentium, Core, Core Vpro, Xeon, or Itanium class processors available from the Intel Corporation. Many other processors are available. Such a processor usually executes an operating system which may be, for example, the Windows NT, Windows 2000 (Windows ME), Windows XP, Windows Vista, Windows 7 or Windows 8 operating systems available from the Microsoft Corporation, MAC OS Snow Leopard, MAC OS X Lion operating systems available from Apple Computer, the Solaris Operating System available from Sun Microsystems, iOS, Blackberry OS, Windows 7 or 8 Mobile or Android OS operating systems, or UNIX available from various sources. Many other operating systems may be used.

The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used.

One or more portions of the computer system may be distributed across one or more computer systems (not shown) coupled to a communications network. These computer systems also may be general-purpose computer systems. For example, various aspects of the invention may be distributed among one or more computer systems configured to provide a service (e.g., servers) to one or more client computers, or to perform an overall task as part of a distributed system. For example, various aspects of the invention may be performed on a client-server system that includes components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP).

It should be appreciated that the invention is not limited to executing on any particular system or group of systems. Also, it should be appreciated that the invention is not limited to any particular distributed architecture, network, or communication protocol.

Various embodiments of the present invention may be programmed using an object-oriented programming language, such as SmallTalk, Java, C++, Ada, or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented using various Internet technologies such as, for example, the well-known Common Gateway Interface (CGI) script, PHP Hyper-text Preprocessor (PHP), Active Server Pages (ASP), HyperText Markup Language (HTML), Extensible Markup Language (XML), Java, JavaScript, Asynchronous JavaScript and XML (AJAX), Flash, and other programming methods. Further, various aspects of the present invention may be implemented in a cloud-based computing platform, such as the well-known EC2 platform available commercially from Amazon.com, Seattle, Wash., among others. Various aspects of the invention may be implemented as programmed or non-programmed elements, or any combination thereof.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A distributed system for processing an item for sale, the system comprising:
a system configured to issue a payment instrument to a customer in exchange for a guaranteed sales item associated with a limited sale at a retail location of a retailer, the guaranteed sales item not being available from on-hand stock at the retail location; and
a system configured to redeem the payment instrument for the guaranteed sales item.

2. The system according to claim 1, wherein the system includes an interface that permits the customer to redeem the payment instrument.

3. The system according to claim 1, wherein the guaranteed sales item associated with a limited sale at a retail location is allocated within a stream of commerce of the retailer responsive to the purchase of the payment instrument by the customer.

4. The system according to claim 2, wherein the interface is configured to accept an access code provided by the customer to redeem the payment instrument.

5. The system according to claim 1, wherein the payment instrument is at least one of a group comprising an actual gift card, a virtual gift card, a prepaid card, and a debit card.

6. The system according to claim 1, wherein the system is configured to generate an access code to the customer responsive to the issue of the payment instrument.

7. The system according to claim 6, wherein the system stores the access code and stores an association of the code with an identification of the guaranteed sales item associated with the limited sale at the retail location of the retailer.

8. The system according to claim 1, wherein the system is further configured to restrict redemption of the payment instrument to the guaranteed sales item.

9. The system according to claim 1, wherein the system is further configured to restrict redemption of the payment instrument to one or more sales items associated with the limited sale at the retail location.

10. The system according to claim 2, wherein the interface is configured to permit the user to select from a limited number of sales items for redemption.

11. The system according to claim 2, wherein the interface is configured to permit the user to select a shipping destination for the guaranteed sales item.

12. The system according to claim 11, wherein the shipping destination includes at least one of a group comprising a retail location, a location associated with a customer, and a location associated with a third party.

13. The system according to claim 7, wherein the system permits the customer to redeem the payment instrument responsive to providing the access code.

14. The system according to claim 13, wherein the system permits the customer to provide an identifier of the payment instrument and the access code to redeem the guaranteed item.

15. The system according to claim 3, wherein the system is configured to provide a guaranteed delivery time limit of the guaranteed item to the customer.

16. The system according to claim 1, further comprising a system configured to fulfill an order for the guaranteed item.

17. The system according to claim 16, wherein the system that is configured to fulfill the order for the guaranteed item is configured to allocate the guaranteed item within a supply chain of the retailer.

18. The system according to claim 17, wherein the system that is configured to fulfill the order for the guaranteed item is configured to schedule delivery by a guaranteed time limit for the guaranteed item.

19. A computer-implemented method for processing an item for sale, the method comprising acts of:
issuing, by a computer system, a payment instrument to a customer in exchange for a guaranteed sales item associated with a limited sale at a retail location of a retailer, the guaranteed sales item not being available from on-hand stock at the retail location; and
redeeming the payment instrument for the guaranteed sales item.

20. The method according to claim 19, further comprising an act of permitting the customer to redeem the payment instrument using an interface of the computer system.

21. The method according to claim 19, wherein the guaranteed sales item associated with a limited sale at a retail location is allocated within a stream of commerce of the retailer responsive to an act of purchasing the payment instrument by the customer.

22. The method according to claim 20, further comprising an act of accepting, by the interface, an access code provided by the customer to redeem the payment instrument.

23. The method according to claim 19, wherein the payment instrument is at least one of a group comprising an actual gift card, a virtual gift card, a prepaid card, and a debit card.

24. The method according to claim 19, further comprising an act of generating, by the computer system, an access code to the customer responsive to the issue of the payment instrument.

25. The method according to claim 24, wherein the computer system is configured to store the access code and the method comprises an act of storing an association of the access code with an identification of the guaranteed sales item associated with the limited sale at the retail location of the retailer.

26. The method according to claim 19, further comprising an act of restricting redemption of the payment instrument to the guaranteed sales item.

27. The method according to claim 19, further comprising an act of restricting redemption of the payment instrument to one or more sales items associated with the limited sale at the retail location.

28. The method according to claim 21, further comprising an act of permitting the user, to within the interface, to select from a limited number of sales items for redemption.

29. The method according to claim 21, further comprising an act of permitting the user, within the interface, to select a shipping destination for the guaranteed sales item.

30. The method according to claim 29, wherein the shipping destination includes at least one of a group comprising a retail location, a location associated with a customer, and a location associated with a third party.

31. The method according to claim 25, further comprising an act of permitting the customer, within the interface, to redeem the payment instrument responsive to providing the access code.

32. The method according to claim 31, further comprising an act of permitting the customer, within the interface, to provide an identifier of the payment instrument and the access code to redeem the guaranteed item.

33. The method according to claim 21, further comprising an act of providing, by the computer system, a guaranteed delivery time limit of the guaranteed item to the customer.

34. The method according to claim 19, further comprising an act of fulfilling, by a fulfillment system, an order for the guaranteed item.

35. The method according to claim 34, further comprising an act of allocating, by the fulfillment system, the guaranteed item within a supply chain of the retailer.

36. The method according to claim 35, further comprising an act of scheduling, by the fulfillment system, delivery of the guaranteed item by a guaranteed time limit
